(19) United States
(12) Patent Application Publication
(10) Pub. No.: US 2026/0214482 A1
(43) Pub. Date: Jul. 23, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Jing Wang, Haidian District, Beijing (CN); Lan Chen, Haidian District, Beijing (CN)

(73) Assignee: NTT DOCOMO, INC., Tokyo (JP)

(21) Appl. No.: 18/865,570

(22) PCT Filed: Mar. 10, 2023
(86) PCT No.: PCT/JP2023/009352

§ 371 Date: Nov. 13, 2024

(30) Foreign Application Priority Data
May 18, 2022 (JP) 2022-081819

(51) Int. Cl. H04W 24/10

(52) U.S. Cl. CPC H04W 24/10

(57) ABSTRACT

A terminal according to one aspect of the present disclosure includes: a receiving section that receives information of a plurality of transmission/reception points (TRPs) for measurement of channel state information (CSI); and a control section that determines a group of TRPs of the plurality of TRPs, based on the information. According to one aspect of the present disclosure, it is possible to appropriately perform CSI reporting for multi-TRP/multi-panel.

### TECHNICAL FIELD

The present disclosure relates to a terminal, a radio communication method, and a base station in next-generation mobile communication systems.

### BACKGROUND ART

For a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G);” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), it is studied to report channel state information (CSI) based on reception of a reference signal. It is also studied that a plurality of (multiple) transmission/reception points (TRPs), multi-TRP (Multi TRP (MTRP)), or a plurality of (multiple) panels (multi-panel) perform DL transmission to a terminal (user terminal, User Equipment (UE)). Coherent joint transmission (CJT) using multi-TRP/multi-panel is also studied.

However, configuration/reporting of CSI for multi-TRP/multi-panel has not been sufficiently studied. Unless a method of such configuration/reporting is defined clearly, communication throughput, communication quality, and the like may degrade.

Thus, an object of the present disclosure is to provide a terminal, a radio communication method, and a base station that appropriately perform CSI reporting for multi-TRP/multi-panel.

### Solution to Problem

A terminal according to one aspect of the present disclosure includes: a receiving section that receives information of a plurality of transmission/reception points (TRPs) for measurement of channel state information (CSI); and a control section that determines a group of TRPs of the plurality of TRPs, based on the information.

### Advantageous Effects of Invention

According to one aspect of the present disclosure, it is possible to appropriately perform CSI reporting for multi-TRP/multi-panel.

### BRIEF DESCRIPTION OF DRAWINGS

FIG. 1 shows an example of a 16-level quantization table.

FIG. 2 shows an example of an 8-level quantization table.

FIGS. 3A and 3B show an example of a Rel-16 Type 2 port selection codebook.

FIGS. 4A and 4B show an example of a Rel-17 Type 2 port selection codebook.

FIG. 5 shows an example of a precoding matrix for multi-TRP.

FIGS. 6A and 6B show examples of inter-site multi-TRP and intra-site multi-TRP.

FIGS. 7A and 7B show examples of a multi-TRP structure according to embodiment #1.

FIG. 8 shows an example of a precoding matrix according to embodiment #2.

FIG. 9 shows an example of association between each TCI codepoint and a corresponding TCI state according to embodiment #6.

FIG. 10 shows another example of the association between each TCI codepoint and a corresponding TCI state according to embodiment #6.

FIGS. 11A and 11B show examples of a restriction according to embodiment #A.

FIG. 12 is a diagram to show an example of a schematic structure of a radio communication system according to one embodiment.

FIG. 13 is a diagram to show an example of a structure of a base station according to one embodiment,

FIG. 14 is a diagram to show an example of a structure of a user terminal according to one embodiment.

FIG. 15 is a diagram to show an example of a hardware structure of the base station and the user terminal according to one embodiment.

FIG. 16 is a diagram to show an example of a vehicle according to one embodiment.

### DESCRIPTION OF EMBODIMENTS

### (Multi-TRP)

For NR, it is studied that one or a plurality of transmission/reception points (TRPs) (multi-TRP (multi TRP (MTRP))) perform DL transmission to a UE by using one or a plurality of panels (multi-panel). It is also studied that the UE performs UL transmission to the one or plurality of TRPs by using the one or plurality of panels.

Note that the plurality of TRPs may correspond to the same cell identifier (ID) or may correspond to different cell IDs. The cell ID may be a physical cell ID or may be a virtual cell ID.

The multi-TRP (TRPs #1 and #2) may be connected via ideal/non-ideal backhaul to exchange information, data, and the like. Each TRP of the multi-TRP may transmit a different codeword (Code Word (CW)) and a different layer. As one mode of multi-TRP transmission, non-coherent joint transmission (NCJT) may be employed.

In NCJT, for example, TRP1 performs modulation mapping on a first codeword, performs layer mapping, and transmits a first PDSCH in layers of a first number (for example, two layers) by using first precoding. TRP2 performs modulation mapping on a second codeword, performs layer mapping, and transmits a second PDSCH in layers of a second number (for example, two layers) by using second precoding.

Note that a plurality of PDSCHs (multi-PDSCH) transmitted by NCJT may be defined to partially or entirely overlap in terms of at least one of the time and frequency domains. In other words, the first PDSCH from a first TRP and the second PDSCH from a second TRP may overlap in terms of at least one of the time and frequency resources.

The first PDSCH and the second PDSCH may be assumed not to be in a quasi-co-location (QCL) relationship (not to be quasi-co-located). Reception of the multi-PDSCH may be interpreted as simultaneous reception of PDSCHs of a QCL type other than a certain QCL type (for example, QCL type D).

A plurality of PDSCHs (which may be referred to as multi-PDSCH (multiple PDSCHs)) from the multi-TRP may be scheduled by using one piece of DCI (single DCI (S-DCI), single PDCCH) (single master mode). The one piece of DCI may be transmitted from one TRP of the multi-TRP. The plurality of PDSCHs from the multi-TRP may be separately scheduled by using a plurality of pieces of DCI (multi-DCI (M-DCI), multi-PDCCH (multiple PDCCHs)) (multi-master mode). The plurality of respective pieces of DCI may be transmitted from the multi-TRP. A UE may assume to transmit, to the different TRPs, separate CSI reports related to the respective TRPS. Such CSI feedback may be referred to as separate feedback, separate CSI feedback, and the like. In the present disclosure, “separate” may be interchangeably interpreted as “independent.”

Note that CSI feedback for transmitting, to one TRP, a CSI report related to both TRPs may be used. Such CSI feedback may be referred to as joint feedback, joint CSI feedback, and the like.

For example, in a case of separate feedback, the UE is configured to transmit, to TRP #1, a CSI report for TRP #1 by using a certain PUCCH (PUCCH 1) and transmit, to TRP #2, a CSI report for TRP #2 by using another PUCCH (PUCCH 2). In a case of joint feedback, the UE is configured to transmit, to TRP #1 or #2, a CSI report for TRP #1 and a CSI report for TRP #2.

According to such a multi-TRP scenario, more flexible transmission control using a channel with high quality is possible.

### (CSI Report (or Reporting))

In Rel-15 NR, a terminal (also referred to as a user terminal, a User Equipment (UE), and the like) generates (also referred to as determines, calculates, estimates, measures, and the like) channel state information (CSI), based on a reference signal (RS) (or a resource for the RS), and transmits (also referred to as reports, feeds back, and the like) the generated CSI to a network (for example, a base station). The CSI may be transmitted to the base station by using an uplink control channel (for example, a Physical Uplink Control Channel (PUCCH)) or an uplink shared channel (for example, Physical Uplink Shared Channel (PUSCH)), for example.

The RS used for the generation of the CSI may be at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like, for example.

The CSI-RS may include at least one of a non-zero power (NZP) CSI-RS and CSI-Interference Management (CSI-IM). The SS/PBCH block is a block including the SS and the PBCH (and a corresponding DMRS), and may be referred to as an SS block (SSB) or the like. The SS may include at least one of a primary synchronization signal (PSS) and a secondary synchronization signal (SSS).

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

The UE may receive information related to CSI reporting (report configuration information), and control the CSI reporting, based on the report configuration information. The report configuration information may be, for example, a radio resource control (RRC) information element (IE) “CSI-ReportConfig.” Note that, in the present disclosure, the RRC IE may be interchangeably interpreted as an RRC parameter, a higher layer parameter, and the like.

The report configuration information (for example, the RRC IE “CSI-ReportConfig”) may include at least one of the following, for example.
Information (report type information, for example, an RRC IE “reportConfigType”) related to a type of the CSI report
Information (report quantity information, for example, an RRC IE “reportQuantity”) related to one or more quantities (one or more CSI parameters) of the CSI to be reported
Information (resource information, for example, an RRC IE “CSI-ResourceConfigId”) related to the resource for the RS used for generation of the quantity (the CSI parameter)
Information (frequency domain information, for example, an RRC IE “reportFreqConfiguration”) related to the frequency domain being a target of the CSI report

For example, the report type information may indicate a periodic CSI (P-CSI) report, an aperiodic CSI (A-CSI) report, or a semi-persistent (semi-permanent) CSI (SP-CSI) report.

The report quantity information may specify at least one combination of the above CSI parameters (for example, the CRI, RI, PMI, COI, LI, L1-RSRP, and the like).

The resource information may be an ID of the resource for the RS. The resource for the RS may include, for example, a non-zero power CSI-RS resource or SSB, and a CSI-IM resource (for example, a zero power CSI-RS resource).

The frequency domain information may indicate frequency granularity of the CSI report. The frequency granularity may include, for example, a wideband and a subband. The wideband is the entire CSI reporting band. The wideband may be, for example, the entire of a certain carrier (component carrier (CC, cell, or serving cell) or may be the entire of a bandwidth part (BWP) in a certain carrier. The wideband may be interpreted as CSI reporting band, the entire CSI reporting band, and the like.

The subband may be part of the wideband and constituted of one or more resource blocks (RBs or physical resource blocks (PRBs)). The size of the subband may be determined according to the size of the BWP (the number of PRBs).

The frequency domain information may indicate whether to report a PMI of a wideband or a subband (the frequency domain information may include, for example, an RRC IE “pmi-FormatIndicator” to be used for determination of either wideband PMI reporting or subband PMI reporting). The UE may determine frequency granularity of CSI reporting (specifically, either wideband PMI reporting or subband PMI reporting), based on at least one of the report quantity information and the frequency domain information.

When wideband PMI reporting is configured (determined), one wideband PMI may be reported for the entire CSI reporting band. In contrast, when subband PMI reporting is configured, a single wideband indication i1 may be reported for the entire CSI reporting band, and one subband indication i2 of each of one or more subbands in the entire CSI reporting (for example, a subband indication for each subband) may be reported.

The UE performs channel estimation by using a received RS to estimate a channel matrix H. The UE feeds back an index (PMI) determined based on the estimated channel matrix.

The PMI may indicate a precoder matrix (also simply referred to as a precoder) that the UE considers appropriate for the use for downlink (DL) transmission to the UE. Each value of the PMI may correspond to one precoder matrix. A set of values of the PMI may correspond to a different set of precoder matrices referred to as a precoder codebook (also simply referred to as a codebook).

In the space domain, a CSI report may include one or more types of CSI. For example, the CSI may include at least one of a first type (Type 1 CSI) to be used for selection of a single beam and a second type (Type 2 CSI) to be used for selection of multi-beam. The single beam may be interpreted as a single layer, and the multi-beam may be interpreted as a plurality of beams. Without Type 1 CSI assuming multi-user multiple input multiple output (MIMO), Type 2 CSI may assume multi-user MIMO.

The codebook above may include a codebook for Type 1 CSI (also referred to as Type 1 codebook and the like) and a codebook for Type 2 CSI (also referred to as Type 2 codebook and the like). Type 1 CSI may include Type 1 single-panel CSI and Type 1 multi-panel CSI, for which respective different codebooks (Type 1 single-panel codebook and Type 1 multi-panel codebook) may be defined.

In the present disclosure, Type 1 and Type I may be interchangeably interpreted. In the present disclosure, Type 2 and Type II may be interchangeably interpreted.

Uplink control information (UCI) types may include at least one of Hybrid Automatic Repeat reQuest ACKnowledgement (HARQ-ACK), a scheduling request (SR), and CSI. UCI may be carried by a PUCCH or may be carried by a PUSCH.

In Rel-15 NR, UCI can include one CSI part for wideband PMI feedback. CSI report #n includes PMI wideband information if reported.

In Rel-15 NR, UCI can include two CSI parts for subband PMI feedback. CSI part 1 includes wideband PMI information. CSI part 2 includes one piece of wideband PMI information and several pieces of subband PMI information. CSI part 1 and CSI part 2 may be separately encoded.

In Rel-15 NR, a UE is configured with a report setting(s) for N (N≥1) CSI report configuration(s) and a report setting(s) for M (M≥1) CSI resource configuration(s) by a higher layer. For example, the CSI report configuration (CSI-RepotConfig) includes setting of resources for channel measurement (resources ForChannelMeasurement), setting of a CSI-IM resource for interference (csi-IM-ResourceForInterference), setting of an NZP-CSI-RS resource (nzp-CSI-RS-ResourceForInterference), report quantity (reportQuantity), and the like. Each of the setting of resources for channel measurement, the setting of CSI-IM resource for interference, and the setting of an NZP-CSI RS for interference is associated with a CSI resource configuration (CSI-ResourceConfig, CSI-ResourceConfigId). The CSI resource configuration includes a list of CSI-RS resource sets (csi-RS-ResourceSetList, for example, an NZP-CSI-RS resource set or a CSI-IM resource set).

By targeting both FR1 and FR2, evaluation and definition of a CSI report for transmission of at least one of DL multi-TRP and DL multi-panel are studied to enable more dynamic channel/interference hypotheses for NCJT.

### (Codebook Configuration)

A UE is configured with a parameter related to a codebook (codebook configuration (CodebookConfig)) by higher layer signaling (RRC signaling). The codebook configuration is included in a higher layer (RRC) parameter CSI report configuration (CSI-ReportConfig).

In the codebook configuration, at least one codebook is selected from Type 1 single-panel (typeI-SinglePanel), Type 1 multi-panel (typeI-MultiPanel), Type 2 (typeII), and Type 2 port selection (typeII-PortSelection).

A parameter(s) of a codebook includes a parameter related to a codebook subset restriction (CBSR) ( . . . Restriction). A configuration of the CBSR corresponds to a bit indicating, for a precoder associated with the bit of the CBSR, which PMI report is permitted (“1”) and which PMI report is not permitted (“0”). 1 bit of a CBSR bitmap corresponds to one codebook index/antenna port.

### (CSI Report Configuration)

A CSI report configuration (CSI-ReportConfig) of Rel. 16 includes, in addition to a codebook configuration (CodebookConfig), CSI-RS resources for channel measurement (resources ForChannelMeasurement (CMR)), CSI-RS resources for interference measurement (csi-IM-ResourcesForInterference (ZP-IMR) and nzp-CSI-RS-ResourcesForInterference (NZP-IMR)), and the like. Parameters excluding codebookConfig-r16 of the parameters of CSI-ReportConfig are also included in a CSI report configuration of Rel. 15.

In Rel. 17, an enhanced CSI report configuration (CSI-ReportConfig) for multi-TRP CSI measurement/reporting using NCJT is studied. In the CSI report configuration, two CMR groups corresponding to two respective TRPs are configured. CMRs in a CMR group may be used for measurement of at least one of multi-TRP and a single-TRP using NCJT. N CMR pair(s) of NCJT is configured by RRC signaling. A UE may be configured with whether to use the CMRs of each CMR pair for single-TRP measurement by RRC signaling.

It is studied to support at least one of options 1 and 2 below for CSI reporting related to multi-TRP/panel NCJT measurement configured by a single CSI report configuration.

### <Option 1>

A UE is configured to report X piece(s) of CSI (X=0, 1, 2) related to single-TRP measurement hypotheses and one piece of CSI related to NCJT measurement. In a case of X=2, two pieces of CSI relate to two different single-TRP measurements using CMRs of different CMR groups.

### <Option 2>

A UE may be configured to report one piece of CSI related to the best measurement result among those of NCJT and single-TRP measurement hypotheses.

As described above, in Rel. 15/16, a CBSR is configured for each codebook configuration of each CSI report configuration. In other words, the CBSR is applied to all the CMRs and the like in the corresponding CSI report configuration.

However, in a multi-TRP CSI report configuration of Rel. 17 of CSI report configurations, when any of options 1 and 2 above is applied, measurement configurations as follows may be performed.
Option 1 (X=0): measurement of only NCJT CSI
Option 1 (X=1): measurement of NCJT CSI and single-TRP CSI (one TRP)
Option 1 (X=2): measurement of NCJT CSI and single-TRP CSI (two TRPs)
Option 2: measurement of both NCJT CSI and single-TRP CSI

### (Type 1 Codebook)

For a base station panel, Type 1 single-panel codebook and Type 1 multi-panel codebook are defined. In a Type 1 single panel, antenna models of a CSI antenna port array (logical configuration) is defined for the number P_{CSI-RS} of CSI-RS antenna ports and (N₁, N₂). In Type 1 multi-panel, antenna models of a CSI antenna port array (logical configuration) is defined for the number P_{CSI-RS} Of CSI-RS antenna ports and (N_{g}, N₁, N₂).

For Rel-15 Type 1 single-panel CSI, a UE is set with a higher layer parameter of codebook type (subType in type1 in codebookType in CodebookConfig) at Type 1 single panel (‘typeI-SinglePanel’). In a case other than the number v of layers ∈{2, 3, 4}, a PMI value corresponds to three codebook indices i_{1,1}, i_{1,2}, and i₂. In a case of the number v of layers ∈{2, 3, 4}, a PMI value corresponds to four codebook indices i_{1,1}, i_{1,2}, i_{1,3}, and i₂. In a case other than the number v of layers ∈{2, 3, 4}, composite codebook index i₁=[i_{1,1}, i_{1,2}] holds. In a case of the number v of layers ∈{2, 3, 4}, composite codebook index i₁=[i_{1,1}, i_{1,2}, i_{1,3}] holds.

For the number P_{CSI-RS} of CSI antenna ports, supported configurations (combinations of values) of (N₁, N₂) and (O₁, O₂) are defined in a specification. (N₁, N₂) indicates the number of two-dimensional antenna elements and is configured by n1-n2 in moreThanTwo in nrOfAntennaPorts in typeI-SinglePanel. (O₁, O₂) denotes a two-dimensional over-sampling factor. i_{1,1} corresponding to a horizontal beam corresponds to {0, 1, . . . , N₁O₁−1}. i_{1,2} corresponding to a vertical beam corresponds to {0, 1, . . . , N₂O₂−1}. i₂ corresponds to {0, 1, 2, 3}. For codebook mode (codebookMode)=1, a matrix for 1-layer CSI report codebook using antenna ports 3000 to (2999+P_{CSI-RS}) is W_i_{1,1}, i_{1,2}, i₂\hat{ }(1). Here, W_{1,m,n}⁽¹⁾ is given by the following equation.

$${W}_{l , m , n}^{( 1 )} = \frac{1}{\sqrt{{P}_{CSI - RS}}} [ \begin{matrix}{v}_{l , m} \\ {φ}_{n} {v}_{l , m}\end{matrix} ] \qquad ( X1 )$$

For Rel-15 Type 1 multi-panel CSI, the number N_{g} of panels is configured in addition to N₁ and N₂, compared with a Type 1 single panel. As inter-panel co-phasing (inter-panel phase compensation, phase compensation between panels, inter-panel phase adjustment/phase difference), i,_{1,4} is added for reporting. The same SD beam (precoding matrix W₁) is selected for each panel, and only inter-panel co-phasing is added for reporting.

For the number P_{CSI-RS} of CSI antenna ports, supported configurations (combinations of values) of (N_{g}, N₁, N₂) and (O₁, O₂) are defined in a specification. (N₁, N₂) is configured by ng-n1-n2 in typeI-MultiPanel. i_{1,1} corresponds to {0, 1, . . . , N₁O₁−1}. i_{1,2} corresponds to {0, 1, N₂O₂−1}. For q=1, . . . , N_{g}−1, i_{1,4,q} corresponds to {0, 1, 2, 3}. i₂ corresponds to {0, 1, 2, 3}. For codebook mode (codebookMode)=1, a matrix for 1-layer CSI report codebook using antenna ports 3000 to (2999+P_{CSI-RS}) is W_i_{1,1}, i_{1,2}, i_{1,4}, i₂\hat{ }(1). Here, W_{l,m,p,n}⁽¹⁾=W_{l,m,p,n}\hat{ }1; N_{g}, 1 holds.

W_l,m,p,n\hat{ }1, N_{g},1 and W_l,m,p,n\hat{ }2, N_{g},1 for N_{g}={2, 4} (matrix W_{l,m,p,n}^{1,2,1} for first layer, N_{g}=2, and codeBookMode=1, matrix W_{l,m,p,n}^{2,2,1} for second layer, N_{g}=2, and codeBookMode=1, matrix W_{l,m,p,n}^{1,4,1} for first layer, N_{g}=4, and codeBookMode=1, and matrix W_{l,m,p,n}^{2,4,1} for second layer, N_{g}=4, and codeBookMode=1) are given by the following equations.

$$\begin{matrix}{W}_{l , m , p , n}^{1 , 2 , 1} = \frac{1}{\sqrt{{P}_{CSI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m}\end{matrix} ] & {W}_{l , m , p , n}^{2 , 2 , 1} = \frac{1}{\sqrt{{P}_{CSI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m}\end{matrix} ]\end{matrix} \qquad ( X2 )$$

$${W}_{l , m , p , n}^{1 , 4 , 1} = \frac{1}{\sqrt{{P}_{CSI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m} \\ {φ}_{{p}_{2}} {v}_{l , m} \\ {φ}_{n} {φ}_{{p}_{2}} {v}_{l , m} \\ {φ}_{{p}_{3}} {v}_{l , m} \\ {φ}_{n} {φ}_{{p}_{3}} {v}_{l , m}\end{matrix} ] \qquad {W}_{l , m , p , n}^{2 , 4 , 1} = \frac{1}{\sqrt{{P}_{CSI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m} \\ {φ}_{{p}_{2}} {v}_{l , m} \\ - {φ}_{n} {φ}_{{p}_{2}} {v}_{l , m} \\ {φ}_{{p}_{3}} {v}_{l , m} \\ - {φ}_{n} {φ}_{{p}_{3}} {v}_{l , m}\end{matrix} ]$$

Here, φₙ=e^{jπn/2} holds. For N_{g}=2, p=p₁ holds. For N_{g}=4/p=[p₁, p₂, p₃] holds. φ_p₁, φ_p₂, and φ=p₃ denote inter-panel co-phasing. For panels 0, 1, 2, 3, the same beam (SD beam matrix, precoding matrix W₁) is selected. φ_p₁ denotes phase compensation of panel 1 for panel 0, φ_p₂ denotes phase compensation of panel 2 for panel 0, and φ_p₃ denotes phase compensation of panel 3 for panel 0.

### (Type 2 Codebook)

On the assumption of ideal backhaul, synchronization, the same number of antenna ports over a plurality of TRPs, CSI acquisition for coherent joint transmission (CJT) for FR1 and up to four TRPs is studied. For CJT multi-TRP for FDD, improvement of Rel-16/17 Type 2 codebook is studied.

In the present disclosure, a matrix Z with X row(s) and Y column(s) is sometimes referred to as Z(X×Y).

For Rel-15 Type 2 CSI, generation of a subband (SB)-wise precoding vector is based on the following equation for given layer k.

$${W}_{k} ( {N}_{t} \times {N}_{3} ) = {W}_{1} {W}_{2 , k} \qquad ( Y1 )$$

Nₜ denotes the number of ports. N3 denotes the total number of precoding matrices (precoders) (the number of subbands) indicated by a PMI. W₁(Nₜ×2L) denotes a matrix (SD beam matrix) constituted of L∈{2, 4} (over-sampled) spatial domain (SD) two-dimensional (2D) DFT vectors (SD beams, 2D-DFT vectors). L denotes the number of beams. For example, respective SD 2D-DFT vectors where L=2 are b₁ and bⱼ. W_{2,k}(2L×N₃) denotes a subband complex linear combination (LC) coefficient (combination coefficients) matrix for layer k. W_{2,k} denotes beam selection and co-phasing between two polarizations. For example, two respective W_{2,k} are cᵢ and cⱼ. For example, channel matrix h is approximated by linear combination cᵢbᵢ, +cⱼbⱼ of SD 2D-DFT vectors where L=2. The overhead of feedback is mainly caused by LC coefficient matrix W_{2,k}. Rel-15 Type 2 CSI supports only ranks 1 and 2.

Rel-16 Type 2 CSI reduces overhead related to W_{2,k} by frequency-domain (FD) compression. Rel-16 Type 2 CSI supports ranks 3 and 4 in addition to ranks 1 and 2.

For Rel-16 Type 2 CSI, information based on the following equation may be reported by a UE for given layer k.

$${W}_{k} = {W}_{1} {W}_{k}^{∼} {W}_{f , k}^{H} \qquad ( Y2 )$$

W_{2,k} is approximated by W\tilde{ }ₖW_{f,k}^{H}. Matrix W\tilde{ } may be expressed with ~ above W (w-tilde). Matrix W_{f,k}^{H} is an adjoint matrix of W_{f,k}.

For CSI reporting, the UE may be configured with one of two subband sizes. The subband (CQI subband) may be defined as N_{PRB}^{SB} consecutive PRBs and may depend on the total number of PRBs in a BWP. The number R of PMI subbands per CQI subband is configured by an RRC IE (numberOfPMI-SubbandsPerCQI-Subband). R controls the total number N₃ of precoding matrices indicated by a PMI as a function of the number of subbands configured in csi-ReportingBand, the subband size configured by subbandSize, and the total number of PRBs in the BWP.

W₁(Nₜ×2L) denotes a matrix constituted of a plurality of (over-sampled) spatial domain (SD) 2D-DFTs (vectors, beams). For this matrix, a plurality of indices of two-dimensional discrete Fourier transform (2D-DFT) vectors and a two-dimensional over-sampling factor are reported. Spatial-domain response/distribution expressed by an SD 2D-DFT vector may be referred to as an SD beam.

W\tilde{ }ₖ(2L×Mᵥ) denotes a matrix constituted of combination coefficients (subband complex linear combination (LC) coefficients). For this matrix, K₀ non-zero coefficients (NZCs) are reported at maximum. This report is constituted of two parts including a bitmap from which an NZC position can be caught and a quantization NZC.

W_{f,k}(N₃×Mᵥ) denotes a matrix constituted of a plurality of frequency-domain (FD) bases (vectors) for layer k. Mᵥ FD bases (FD DFT bases) are included for each layer. In a case of N₃>19, Mᵥ DFTs are selected from an intermediate subset (InS) of size N₃′ (<N₃). In a case of N₃≤19, log 2(C(N₃−1, Mᵥ−1)) bits are reported. Here, C(N₃−1, Mᵥ−1) denotes the number of combinations for selecting Mᵥ−1 from N₃−1 and is also referred to as binomial coefficients. Frequency-domain response/distribution (frequency response) expressed by linear combination of FD base vectors and combination coefficients may be referred to as an FD beam. The FD beam may correspond to a delay profile (time response).

A subset of FD bases is given as {f₁, . . . , F_{Mv}}. Here, fᵢ denotes the i-th FD base for the k-th layer, where i∈{1, . . . , Mᵥ}. The PMI subband size is given by a CQI subband size/R, where R∈{1, 2}. The number Mᵥ of FD bases for given rank v is given by ceil (pᵥ×N₃/R). The number of FD bases is the same for all layers k∈{1, 2, 3, 4}. pᵥ is configured by a higher layer.

Each row of matrix W_{2,k} represents a channel frequency response of a specific SD beam. When the SD beam has high directivity, channel taps per beam are limited (power delay profile is coarse in the time-domain). Consequently, channel frequency responses per SD beam have a high correlation (come close to being flat in the frequency domain). In this case, channel frequency responses can be approximated by linear combination of a small number of FD bases. For example, in a case of Mᵥ=2, by using FD bases f₂, f_{q} and linear combination coefficients d₁⁰, d₂⁰, frequency responses associated with SD beam b₀ are approximated by d₁⁰f₂+, d₂⁰f_{q}.

For the highest gain, Mᵥ FD bases are selected. By setting as Mᵥ<<N₃, overhead of W\tilde{ }ₖ results in being significantly smaller than overhead of W_{2,k}. All or part of the Mᵥ FD bases is used for approximation of frequency responses of each SD beam. To report only the FD bases selected for each SD beam, a bitmap is used. If no bitmap is reported, all the FD bases for each SD are selected. In this case, for each SD beam, non-zero (nonzero) coefficients (NZCs) of all the FD bases are reported. The maximum number Kₖ^{NZ} of NZCs in one layer ≤K₀=ceil(β×2LMᵥ) holds, and the maximum number K^{NZ} of NZCs over all the layers ≤2K₀=ceil(β×2LMᵥ) holds. β is configured by a higher layer.

Each complex coefficient in W\tilde{ }ₖ corresponds to an amplitude and a phase quantized separately.

### {Amplitude Quantization}

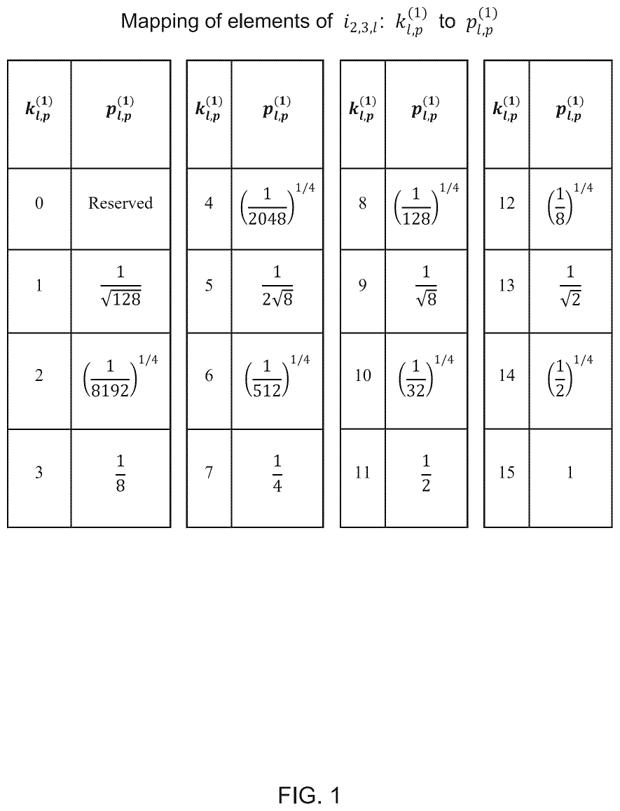

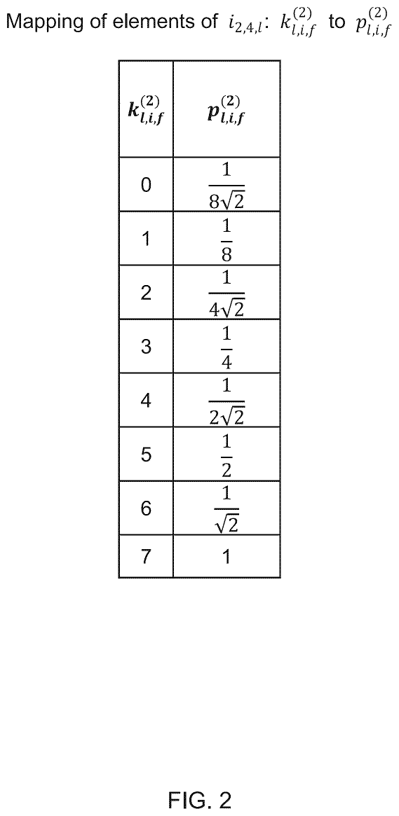

Polarized-wave-specific reference amplitudes correspond to 16-level quantization using a table in FIG. 1 (mapping of a plurality of elements of amplitude coefficient indicator i_{2,3,1}: mapping from element k_{l,p}⁽¹⁾ to amplitude coefficient p_{l,p}⁽¹⁾). All the other coefficients correspond to 8-level quantization using a table in FIG. 2 (mapping of a plurality of elements of amplitude coefficient indicator i_{2,4,1}: mapping from element k_{l,i,f}⁽²⁾ to amplitude coefficient p_{l,i,f}⁽²⁾),

### {Phase Quantization}

All the coefficients are quantized by using 16-PSK, For example, φ_{1,1}=exp(j2πc_{i,i}/16) and c_{i,i}∈{0, . . . , 15} hold. Here, c_{1,i} is a phase coefficient reported by a UE for associated phase value φ_{1,i} (by using 4 bits).

Type 2 CSI feedback on a Rel-16 PUSCH includes two parts. CSI part 1 has a fixed payload size and is used for identification of the number of information bits in CSI part 2. The size of part 2 is variable (UCI size depends on the number of non-zero amplitude coefficients (NZCs), which is not known by a base station). The UE reports the number of NZCs in CSI part 1, and the number determines the size of CSI part 2. The base station receives CSI part 1 and then recognizes the size of CSI part 2.

In enhanced Type 2 CSI feedback, CSI part 1 includes an RI, a CQI, indication of the total number of non-zero amplitudes over a plurality of layers corresponding to enhanced type 2 CSI. The fields of part 1 are encoded separately. CSI part 2 includes a PMI of enhanced Type 2 CSI. Parts 1 and 2 are encoded separately. CSI part 2 (PMI) includes at least one of an over-sampling factor, a 2D-DFT base index, index Mᵢₙᵢₜᵢₐₗ of an initial DFT base (start offset) of a selected DFT window, a DFT base selected for each layer, a non-zero LC coefficient (NZC, amplitude and phase) per layer, a strongest coefficient indicator (SCI) per layer, and an amplitude of the strongest coefficient per layer/polarized wave.

A plurality of PMI indices (PMI values, codebook indices) associated with different pieces of CSI part 2 information may comply with the following for the k-th layer.
i_{1,1}: over-sampling factor
i_{1,2}: a plurality of indices of 2D-DFT bases
i_{1,5}: index (start offset) Mᵢₙᵢₜᵢₐₗ of an initial DFT base of a selected DFT window
i_{1,6,k}: DFT base selected for the k-th layer
i_{1,7,k}: bitmap for the k-th layer
i_{1,8,k}: strongest (highest strength) coefficient indicator (SCI) for the k-th layer
i_{2,3,k}: amplitude of the strongest coefficient (for both polarized waves) of the k-th layer
i_{2,4,k}: amplitude of a reported coefficient of the k-th layer
i_{2,5,k}: phase of a reported coefficient for the k-th layer

i_{1,5} and i_{1,6,k} are PMI indices for DFT base reporting. Only in a case of N₃>19, i_{1,5} is reported.

As grouping for CSI part 2, pieces of PMI information are divided into three groups (groups 0 to 2) for a given CSI report. This is important in a case where CSI omission is performed. Each of reported elements of indices i_{2,4,1}, i_{2,5,1}, and i_{1,7,1} is associated with a specific priority rule. Groups 0 to 2 comply with the following.
Group 0: indices i_{1,1}, i_{1,2}, and i_{1,8,l} (l=1, . . . , v)
Group 1: index i_{1,5} (when reported), highest (higher) (v2LMᵥ−floor (K^{NZ}/2)) priority element(s) of those of indices i_{1,6,l} and i_{1,7,l} (when reported), highest (higher) (ceil(K^{NZ}/2)−v) priority element(s) of those of i_{2,3,l} and i_{2,4,l}, and highest (higher) (ceil(K^{NZ}/2)−v) priority element(s) (l=1, . . . , v) of those of i_{2,5,l}
Group 2: lowest (lower) floor(K^{NZ}/2) priority element(s) of those of i_{1,7,l}, lowest (lower) floor(K^{NZ}/2) priority element(s) of those of i_{2,4,l}, and lowest (lower) floor(K^{NZ}/2) priority element(s) (l=1, . . . , v) of those of i_{2,5,l}

In Type 1 CSI, an SD beam expressed by an SD DFT vector is transmitted toward a UE. In Type 2 CSI, L SD beams are linear-combined and transmitted toward a UE. Each SD beam can be associated with a plurality of FD beams. For the corresponding SD beam, FD base vectors of the SD beams are linearly combined to thereby be able to obtain channel frequency responses. The channel frequency responses correspond to a power delay profile.

### (Type 2 Port Selection Codebook)

In Rel-16 Type 2 port selection (PS) CSI, a Type 2 PS codebook (CB) does not require a UE to derive an SD beam in consideration of 2D-DFT in a normal Type 2 CB. Instead, a base station uses K CSI-RS port(s) beamformed in consideration of a set of SD beams to transmit a CSI-RS. The UE identifies the best L (≤K) CSI-RS port(s) and reports the index (indices) of the L CSI-RS port(s) in W₁.

For layer k∈{1, 2, 3, 4}, subband (SB)-wise precoder generation is given by the following equation.

$${W}_{k} ( {N}_{t} \times {N}_{3} ) = {QW}_{1} {W}_{k}^{∼} {W}_{f , k}^{H} \qquad ( Y3 )$$

Here, Q(Nₜ×K) indicates K SD beam(s) used for CSI-RS beamforming. W₁(K×2L) denotes a block diagonal matrix. W\tilde{ }ₖ(2L×M) denotes an LC coefficient matrix. W_{f,k}(N₃×M) is constituted of N₃ DFT base vectors (FD base vectors). K is configured by a higher layer. L is configured by a higher layer. P_{CSI-RS}∈{4, 8, 12, 16, 24, 32} holds. In a case of P_{CSI-RS}>4, L∈{2, 3, 4} holds.

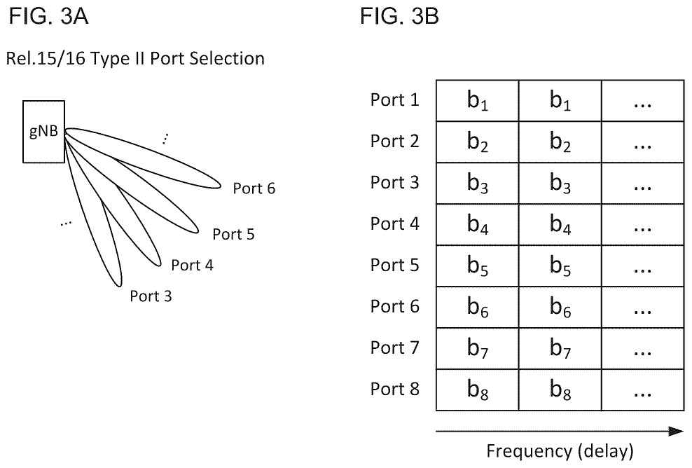

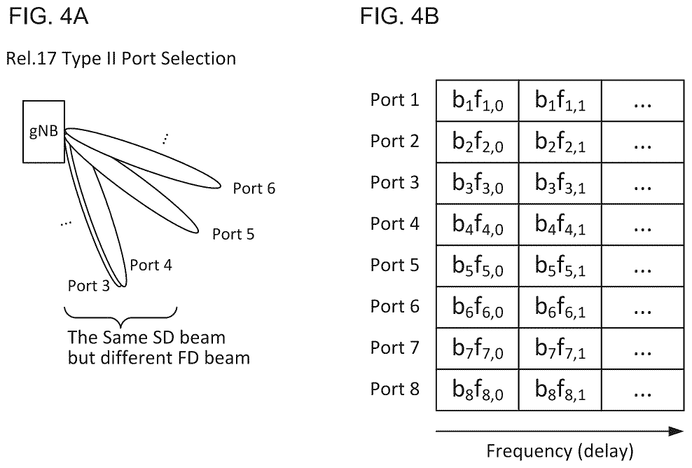

In Rel-15/16 Type 2 port selection CSI/codebook, each CSI-RS port #i is associated with SD beam (bᵢ) (FIGS. 3A and 3B). In Rel-17 Type 2 port selection CSI/codebook (enhanced Type 2 port selection codebook), each CSI-RS port #i is associated with an SD-FD beam pair (pair of SD beam bᵢ and FD beam f_{i,j} (j denotes a frequency index)) (FIGS. 4A and 4B) instead of an SD beam. In this example, ports 3 and 4 are associated with the same SD beam and associated with different FD beams.

Frequency selectivity of channel frequency responses observed in the UE based on an SD-beam-FD-beam pair can be reduced more than frequency selectivity of channel frequency responses observed in the UE based on an SD beam, by delay pre-compensation.

A main scenario of a Rel-17 Type 2 port selection codebook is FDD. Although channel reciprocity based on SRS measurement is not complete, but a base station can obtain some pieces of partial information. By using SRS measurement in the base station in addition to CSI reporting, the base station can obtain CSI for determination of a DL MIMO precoder. In this case, to reduce CSI overhead, some CSI reports may be omitted.

In Rel-17 Type 2 PS CSI, each CSI-RS port is beamformed by using an SD beam and an FD base vector. Each port is associated with an SD-FD pair.

For given layer k, information based on the following equation may be reported by a UE.

$${W}_{k} ( K \times {N}_{3} ) = {W}_{1} {W}_{k}^{∼} {W}_{f , k}^{H} \qquad ( Y4 )$$

For W₁ (K×2L), each matrix block is constituted of L columns of (K×K) unit matrix (identity matrix). The base station transmits K beamformed CSI-RS port(s). Each port is associated with an SD-FD pair. The UE selects L port(s) from K port(s) and reports the L port(s) to the base station as part of PMI (W_{1,k}), In Rel. 16, each port is associated with an SD beam.

W\tilde{ }ₖ(2L×Mᵥ) denotes a matrix constituted of combination coefficients (subband complex LC coefficients). K₀ NZCs are reported at maximum. The report is constituted of two parts including a bitmap from which an NZC position can be caught and a quantization NZC. In a specific case, a bitmap can be omitted. In Rel. 16, a bitmap of NZC position is always reported.

W_{f,k}(N₃×Mᵥ) denotes a matrix constituted of N₃ FD base (FD DFT base) vectors. Mᵥ FD bases are included for each layer. The base station may turn off W_{f,k}. When W_{f,k} is on, additional Mᵥ FD bases are reported. When W_{f,k} is off, no additional FD base is reported. In Rel. 16, W_{f,k} is always reported.

### (CJT)

Joint transmission (JT) may mean simultaneous data transmission from a plurality of points (for example, TRPs) to a single UE.

Rel. 17 supports NCJT from two TRPs. PDSCHs from two TRPS may be independently precoded and independently decoded. Frequency resources may be non-overlapping, may be partial-overlapping, or may be full-overlapping. When overlap occurs, the PDSCH from one TRP interferes the PDSCH from the other TRP.

For Rel. 18, supporting of CJT using up to four TRPs is studied. Data from the four TRPs may be coherently precoded and transmitted to a UE on the same time-frequency resource. For example, in consideration of channels from the four TRPs, the same precoding matrix may be used. “Coherent” may mean the phases of a plurality of received signals have a fixed relationship. By using 4-TRP joint precoding, signal quality may be improved to have no interference among the four TRPs. The data may receive only interference from those other than the four TRPs.

In an ideal case (where four TRPs are co-located (regarded as being at the same location)), joint estimation of an aggregated channel matrix H can be performed to feed back a joint precoding matrix V. However, large scale pathloss may be significantly different among four paths. The joint precoding matrix V based on a constant module codebook is not accurate. In this case, feedback per TRP and an inter-TRP coefficient can be adjusted by a current NR Type 2 codebook.

For CJT of up to four TRPs in FR1, selection of the four TRPs may be semi-static. Hence, the selection and also configuration of four CMRs (four CSI-RS resource) for channel measurement may be static. Dynamic indication of four TRPs from a list of CSI-RS resources is also possible but is less likely.

Pathloss to the UE is different among the four TRPs. Hence, it is difficult only by reporting one aggregated CSI expressing a joint channel matrix.

In consideration of fallback operation to NCJT (i.e., a single TRP), CSI per TRP (i.e., single-TRP CSI as Rel-17 NCJT CSI) is also conceivable.

### (Rel-17 NCJT CSI)

For Rel-17 NCJT CSI, two CMR groups with (Ks=K1+K2) CMRs are configured for the UE. Each of K1 and K2 denotes the number of CMRs in the two CMR groups. By selection from all possible pairs, N CMR pair(s) is configured by a higher layer. N=1 and Ks=2 are supported. Supporting of Nₘₐₓ=2 is an optional function of the UE. Supporting of K_{s,max}=X is an optional function of the UE.

At least one of options 1 and 2 below is supported.

### {Option 1}

The UE may be configured to report X piece(s) of CSI associated with a single-TRP measurement hypothesis (hypotheses) and one piece of CSI associated with an NCJT measurement hypothesis (hypotheses). X=0, 1, 2 holds. In a case of X=2, two pieces of CSI are associated with two different single-TRP measurement hypotheses with a plurality of CMRs from a plurality of different CMR groups. Supporting of X=1, 2 is a UE optional function of the UE supporting option 1.

### {Option 2}

The UE may be configured to report one piece of CSI associated with the best one among NCJT and single-TRP measurement hypotheses.

As CSI enhancement for CJT, the following respects are studied.
CMR and IMR for measurement of up to four TRPs
CSI per TRP with inter-TRP CSI feedback for x-TRP CJT
Inter-TRP CSI: new feedback and codebook for an inter-TRP phase matrix/inter-TRP amplitude matrix/inter-TRP matrix (including both amplitude and phase)
x-TRP CJT CQI that can be additionally reported

As multi-TRP CJT CSI, the following respects are studied.
Restriction of configuration for CMR/CSI for each TRP
Inter-TRP CSI/PMI (for example, inter-TRP phase with/without inter-TRP amplitude)
   {Option 1} In addition to Rel-16/17 Type 2 codebook, independent codebook and feedback.
   {Option 2} W₂ of inter-TRP CSI/PMI transmitted with/in Wₖ\tilde{ }W_{f,k}^{H}. A common/different FD bases for a plurality of TRPs.

As multi-panel Type 2 CSI for multi-TRP CJT, the following respects are studied.
Enhancement of Rel-16/17 Type 2 codebook and Type 2 PS codebook to multi-panel
New antenna configuration for Type 2 multi-panel codebook

### (Multi-TRP CJT CSI)

W₁ (SD base)/W_{f} (FD base) for each TRP may be the same or may be different. Wₖ (NZC) for each TRP may be different. Wₗ/W_{f}/Wₖ for each TRP may be jointly selected or may be individually selected. For design of Wₗ/W_{f}/Wₖ, different scenarios with different options are preferable. W_{φ} may be reported as individual contents or may be reported in Wₖ. These courses to be used relate to an arrangement scenario (for example, intra-site multi-TRP or inter-site multi-TRP).

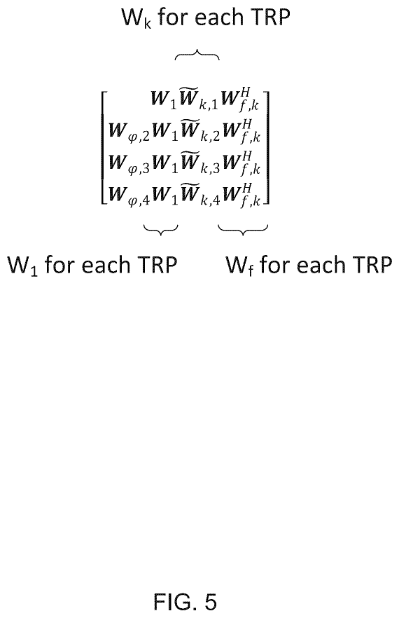

For example, as shown in FIG. 5, a precoding matrix for 4-TRP CJT CSI (codebook) may be expressed by Wₗ/W_{f}/Wₖ for each TRP. W₁ for each TRP may be the same, may be different, may be jointly selected, or may be individually selected. Wₖ for each TRP may be different, may be jointly selected, or may be individually selected. W_{f} for each TRP may be the same, may be different, may be jointly selected, or may be individually selected.

### (Problem #1)

Two options in a case where a plurality of CMRs are configured for x-TRP in CSI-ReportConfig are studied.

### {Option 1}

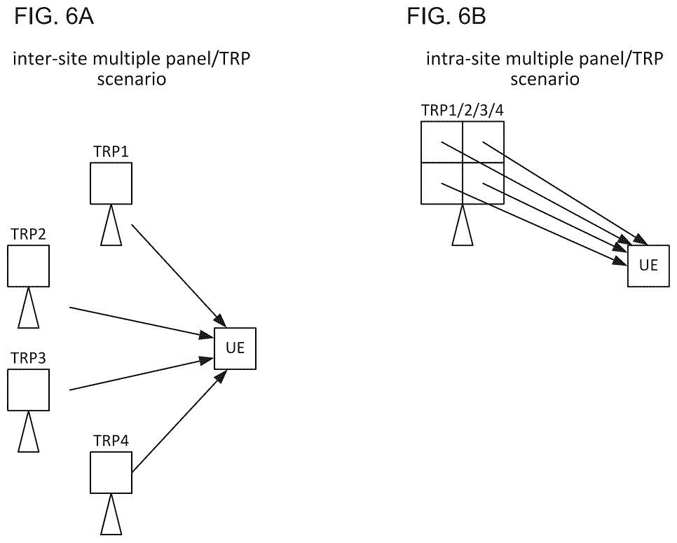

Up to X resource(s) (CMR(s)/CMR group(s)/CSI-RS resource(s)/CSI-RS resource set(s)) can be configured. Each resource corresponds to one TRP. This is preferable in an inter-site multi-TRP scenario (FIG. 6A).

### {Option 2}

For CJT CSI measurement, one or more N-port CSI-RS resources can be configured. One or more ports correspond to one TRP. This is preferable in an intra-site multi-panel/TRP scenario (FIG. 6B). Intra-site and inter-site multi-TRP may be configured by higher layer signaling, but need not be configured. Respective values {Mode0, Mode1} of an RRC parameter for the configuration may correspond to intra-site and inter-site multi-TRP, or vice versa. Intra-site and inter-site multi-TRP may be implied by the configuration of option 1 or 2.

The problem is whether or not to be able to consider hybrid of intra-site and inter-site multi-TRP scenarios. For example, a CMR configuration for the hybrid scenario, an options of design of Wₗ/W_{f}/Wₖ for the hybrid scenario, and a restriction per TRP or over TRPs in the hybrid scenario are problems.

### (Problem #2)

In embodiment #A, if CMR for X=4 is configured, a UE may report CSI for each of four TRPs (X=4) with a plurality of pieces of inter-TRP CSI. In this case, a base can calculate multi-TRP CSI for any of 2-TRP CSI, 3-TRP CSI, and 4-TRP CSI. With high report overhead, high flexibility can be achieved. To reduce the report overhead, not reporting all pieces of CSI for four TRPs (X=4) is conceivable,

### (Problem #3)

Enhancement by adding CUT CSI to existing Rel-16/17 Type 2 codebooks is studied. In TDD operation, for a CJT CSI configuration, it is studied to configure a report quantity configuration (reportQuantity) set at ‘cri-RI-CQI’ (or ‘cri-RI-i1,’ ‘cri-RI-i1-CQI’). In this case, with no need of PMI reporting, a base station can obtain DL precoding from a UL SRS. However, it is necessary to report RI/CQI for DL CJT CSI. Since DL and UL are different in interference, the base station cannot obtain DL CQI from a UL SRS. Enhancement of reportQuantity set at ‘cri-RI-CQI’ (or ‘cri-RI-i1,’ ‘cri-RI-i1-CQI’) is a problem.

### (Problem #4)

If three or four TRPs are transmitted coherently to a UE, enhancement of ICI state indication is a problem.

Thus, study about CJT CSI using multi-TRP/multi-panel is not sufficient. Unless such study is sufficient, communication throughput/communication quality may degrade.

Thus, the inventors of the present invention came up with the idea of operation related to CJT CSI using multi-TRP/multi-panel.

Embodiments according to the present disclosure will be described in detail with reference to the drawings as follows. Note that the embodiments (for example, cases) to be described below may each be employed individually, or at least two of the embodiments may be employed in combination.

In the present disclosure, “A/B” and “at least one of A and B” may be interchangeably interpreted. In the present disclosure, “A/B/C” may mean “at least one of A, B, and C.”

In the present disclosure, “activate,” “deactivate,” “indicate,” “select,” “configure,” “update,” “determine,” and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, time domain resource allocation and time domain resource assignment may be interchangeably interpreted.

In the present disclosure, a beam, an SD beam, an SD vector, and an SD 2D-DFT vector may be interchangeably interpreted. L, the number of SD beams, and the number of SD 2D-DFT vectors may be interchangeably interpreted.

In the present disclosure, an FD base, an FD DFT base, a DFT base, and fᵢ may be interchangeably interpreted. In the present disclosure, an FD beam, an FD vector, an FD base vector, an FD DFT base vector, and a DFT base vector may be interchangeably interpreted.

In the present disclosure, a combination coefficient, an LC coefficient, a subband complex LC coefficient, and a combination coefficient matrix may be interchangeably interpreted.

In the present disclosure, a panel, a base station (gNB) panel, and a TRP may be interchangeably interpreted.

In the present disclosure, co-phasing, phase compensation, phase adjustment, a phase difference, and a phase relationship may be interchangeably interpreted.

In the present disclosure, layer k and layer l may be interchangeably interpreted.

### (Radio Communication Method)

In each embodiment, at least one of a Rel-16 Type 2 CSI report, a Rel-16 Type 2 port selection CSI report, and a Rel-17 Type 2 port selection CSI report described above may be regarded as single-TRP CSI or single-panel CSI.

In each embodiment, X TRP(s), X-TRP, X panel(s), and Ng panel(s) may be interchangeably interpreted. In each embodiment, CJT using X TRP(s), CJT using X panel(s), and X-TRP CJT may be interchangeably interpreted.

In each embodiment, reference CSI, CSI for a reference TRP, and CSI reported first may be interchangeably interpreted. In each embodiment, a reference TRP, CSI corresponding to reference CSI, a TRP corresponding to CSI reported first, a CSI-RS resource/CMR/CMR group/CSI-RS resource set corresponding to CSI reported first may be interchangeably interpreted. In each embodiment, a TRP, a CSI-RS resource, a CMR, a CMR group, and a CSI-RS resource group may be interchangeably interpreted.

In each embodiment, multi-TRP, multi-panel, intra-site multi-TRP, and inter-site multi-TRP may be interchangeably interpreted.

In each embodiment, inter-TRP, inter-panel, an inter-TRP difference, and an inter-TRP comparison may be interchangeably interpreted.

In each embodiment, inter-TRP CSI, inter-TRP CJT CSI, inter-panel CSI, CSI of another TRP for CSI of a reference TRP, and CSI of another TRP for CSI of a reference panel may be interchangeably interpreted. In each embodiment, per-TRP CSI and per-panel CSI may be interchangeably interpreted.

In each embodiment, an inter-TRP phase index and an inter-TRP phasing index may be interchangeably interpreted. In each embodiment, an inter-TRP index and an inter-TRP coefficient index may be interchangeably interpreted. In each embodiment, an inter-TRP phase matrix and an inter-TRP phasing matrix may be interchangeably interpreted. In each embodiment, an inter-TRP matrix and an inter-TRP coefficient matrix may be interchangeably interpreted. In each embodiment, an inter-TRP phase codebook and an inter-TRP phasing codebook may be interchangeably interpreted. In each embodiment, an inter-TRP codebook and an inter-TRP coefficient codebook may be interchangeably interpreted.

In each embodiment, a target resource, a CMR, a CSI-RS resource, an NZP-CSI-RS resource, a CMR group, a CSI-RS resource set, an NZP-CSI-RS resource set, and a TRP may be interchangeably interpreted.

In each embodiment, an inter-TRP codebook, a plurality of panel codebooks for Type 2 codebook, and an inter-panel codebook may be interchangeably interpreted.

In each embodiment, an FD base vector size, the number of FD bases, an Mᵥ size, Mᵥ, and M_{v,i} may be interchangeably interpreted.

In each embodiment, a plurality of TRPs/plurality of CMRs being co-located and intra-site multi-TRP may be interchangeably interpreted.

In each embodiment, a report/content of CSI may be applied to subband reporting or may be applied to wideband reporting.

For problem #1 described above, at least one of embodiments #1 to #3 below may be applied.

### Embodiment #1

In a CMR configuration, additional indication for a plurality of TRPs/plurality of CMRs co-located (provided at the same location) as an intra-site/CMR group (or inter-site TRP) may be supported.

Related to measurement and reporting of Wₗ/W_{f}/Wₖ, a UE performs different operations for a plurality of intra-site or inter-site TRPs. If the additional indication is for a plurality of intra-site CMRs, and the additional indication is absent, the UE may assume that all the plurality of CMRs are a plurality of inter-site TRPs as default. If the additional indication is for a plurality of inter-site CMRs, and the additional indication is absent, the UE may assume that all the plurality of CMRs are a plurality of intra-site TRPs as default.

For example, when X CMR(s) (X CSI-RS resource(s)) are configured in one CSI report configuration (CSI-ReportConfig), each resource may correspond to one (inter-site) TRP (X-TRPs, for example, X=4), and the additional indication may indicate at least one of first two CMRs being co-located as a plurality of intra-site TRP and last two CMRs being co-located as a plurality of TRPS.

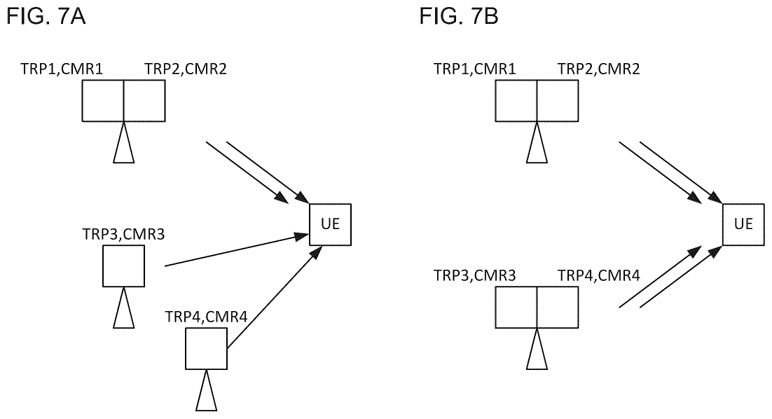

In the example in FIG. 7A, CMR1 to CMR4 are associated respectively with TRP1 to TRP4 (CMR1 to CMR4 are transmitted respectively from TRP1 to TRP4). If TRP1 and TRP2 are co-located, CMR1 and CMR2 may be indicated as a CMR group.

In the example in FIG. 7B, CMR1 to CMR4 are associated respectively with TRP1 to TRP4 (CMR1 to CMR4 are transmitted respectively from TRP1 to TRP4). (If the UE assumes a plurality of inter-site CMRs as default,) when TRP1 and TRP2 are co-located, and TRP3 and TRP4 are co-located, CMR1 and CMR2 may be indicated as a CMR group, and CMR3 and CMR4 may be indicated as a CMR group.

According to this embodiment, a UE can be appropriately indicated with a plurality of co-located TRPs/CMRs.

### Embodiment #2

If additional information of CMR grouping for intra-site/inter-site multi-TRP is configured, a UE may apply different courses to a plurality of CMRs from intra-site multi-TRP and a plurality of CMRs from inter-site multi-TRP as indicated for multi-TRP CJT CSI described above.

For a plurality of CMRs as inter-site multi-TRP, the UE may apply course #1 to W₁/W_{f}/W₂/Wₖ. For example, in course #1, W₁ may be different for each TRP, W_{f} may be different for each TRP, and W₂ may be different for each TRP. W₁/W_{f}/W₂/Wₖ may be individually selected for each TRP or may be jointly selected over a plurality of TRPS. We may be individual contents for each TRP.

For a plurality of CMRs as intra-site multi-TRP, the UE may apply course #2 to W₁/W_{f}/W₂/Wₖ. For example, in course #1, W₁ may be the same for each TRP, and We may be the same for each TRP, W₁/W_{f}/W₂/Wₖ may be jointly selected over a plurality of TRPS. W_{φ} may be individual contents for each TRP.

A network (NW) may directly configure that some TRPs (for example, CMRs/CMR group/CSI-RS resources/CSI-RS resource set) are to comply with a certain course for W₁/W_{f}/W₂/Wₖ. For example, the NW may configure that CMR1 and CMR2 are to have the same W₁/W_{f} report. The NW may configure that CMR3, CMR4, and CMR1/2 are to have different W₁/W_{f} reports.

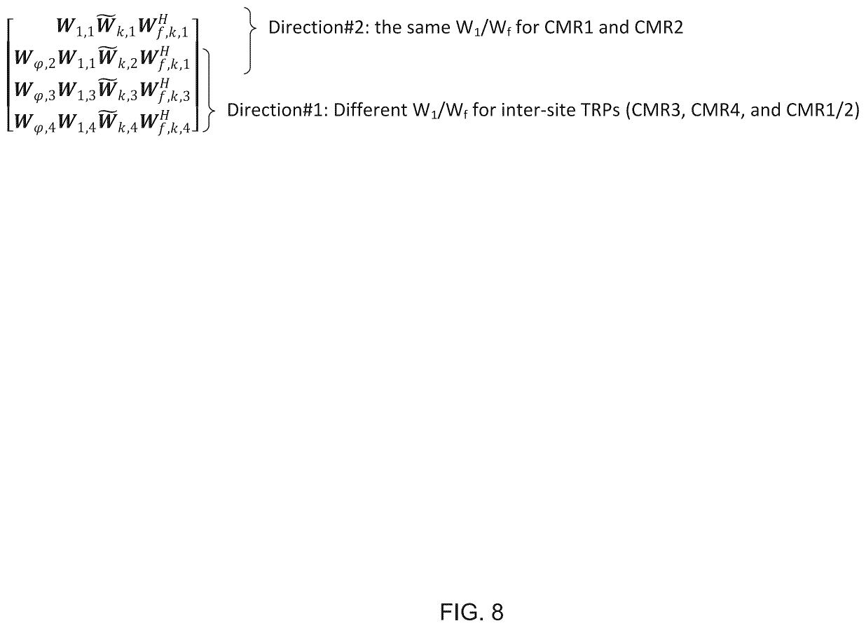

In the example of a precoding matrix in FIG. 8, if TRP1 and TRP2 are co-located (CMR1 and CMR2 correspond to intra-site), course #1 may be that W₁/W_{f} is different for a plurality of inter-site TRPs (CMR3, CMR4, and CMR1/2), and course #2 may be that W₁/W_{f} is the same for CMR1 and CMR2.

According to this embodiment, a UE can be appropriately indicated with CMR grouping for a plurality of TRPS.

### Embodiment #3

If additional information of CMR grouping for intra-site/inter-site multi-TRP is configured, a UE may apply a configuration of a different restriction for a plurality of parameters in embodiment #A to be described later, for a plurality of CMRs from intra-site multi-TRP and a plurality of CMRs from inter-site multi-TRP.

For example, some parameters may be common to the intra-site multi-TRP or may be individual for the inter-site multi-TRP. In embodiment #A to be described later, a unit in which each restriction is applied may be for each TRP or may be over a plurality of TRPs. In this embodiment, a unit in which each restriction is applied may be for each TRP group (CMR grouping) or may be over a plurality of TRP groups.

According to this embodiment, a UE can be appropriately indicated with CMR grouping for a plurality of TRPs.

For problem #2 described above, embodiment #4 below may be applied.

### Embodiment #4

If a plurality of CMRs for four TRPs (X=4) are configured (or if an NW further configures the maximum number of TRPs/CMRs/CMRs/CMR groups/CSI-RS resource/CSI-RS resource sets to be selected/reported to be X1), a UE may report the number of TRPs/CMRs selected for reporting as X2, as for indices of selected TRPs/CMRs. X2≤X (or X2≤X1) may hold.

Whether or not X2=1 (or X2≥2) is permitted may be further configured by signaling from the NW. X2=1 may imply whether the UE can report fallback CSI for single-TRP transmission.

By assuming X2≥2, whether one additional piece of CSI for a single-TRP can be reported together with X2 pieces of CJT CSI may be further configured by signaling from the NW. If additional single-TRP CSI is configured, the index of the TRP/CMR for the single TRP may also be reported.

### <<Choice 1>>

The number of TRPs/CMRs to be reported may be included in CSI part 1. The payload size of the number may be fixed. The indices of the TRPs/CMRs selected for the X2 TRPs/CMRs may be included in CSI part 2. The payload size of the indices may depend on X2. For CSI part 2, the indices of the X2 TRPs/CMRs may be included in group 0 described above. For example, by assuming 2 bits for a CMR index, (2*X2) bits are needed for the selected CMR indices.

The indices of the TRPs/CMRs to be reported may be reindexed indices of configured CMR resources. For example, when CSI-RS resources #8, #12, #24, and #36 are configured as CMRs from four TRPs, the UE can report X2=2 with two CRI indices (CRI #0, CRI #3) for two TRPs/CMRs. In reporting from the UE, CRI #0 corresponds to CSI-RS resource #8, and CRI #3 corresponds to CSI-RS resource #36.

### <<Choice 2>>

The number of indices of the TRPs/CMRs selected for the X2 TRPs/CMRs may be included in CSI part 1. The payload size of the number may be fixed.

When a bitmap of size X is reported, the bitmap may indicate the number of selected TRPs/CMRs, as for the indices of TRPs/CMRs. No reporting of others may be needed.

The UE may report a plurality of sets of bitmaps each indicating a plurality of combinations of selected TRPs may be reported. For example, 1100 and 1101 respectively expressing 2-TRP CJT CST from TRP1 and TRP2 and 3-TRP CJT CST from TRP1, TRP2, and TRP4 may be reported. 1000 expressing a single-TRP may be reported. The number of sets to be reported may be configured by an RRC IE or may be reported additionally by the UE.

According to this embodiment, a UE can appropriately report the number of TRPs/CMRs selected for reporting.

For problem #3 described above, embodiment #5 below may be applied.

### Embodiment #5

In a CJT CSI configuration, reportQuantity set at ‘cri-RI-CQI’ (or ‘cri-RI-i1,’ ‘cri-RI-i1-CQI’) can be configured, and a UE may measure a CJT CQI with an RI to report the result to an NW. If a plurality of CMRs for four TRPs (X=4) are configured for one CSI-ReportConfig, the UE may follow at least one of the following choices.

### <<Choice 1>>

The UE may report the number X2 of selected TRPs (X2≥2, X2≤X, or X2≤X1), corresponding TRP indices, and a CJT CQI assuming X2-TRP CJT transmission. For example, the UE may report X2=2, CRI #0 and CRI #3, and a CJT COI assuming CJT transmission of CRI #0 and CRI #3. The UE may report a bitmap for indicating the number of selected TRPs and the TRP indices.

### <<Choice 2>>

The UE may report the number X2 of selected TRPs (X2≥2), the number X4 of sets of X2 selected TRPs, and a plurality of sets of TRP indices with corresponding CJT COIs. The UE may report a bitmap for indicating the number of a plurality of selected sets and TRP indices.

### <<Choice 3>>

The UE may report a TRP index for single-TRP transmission and a corresponding single-TRP CQI in addition to CJT CSI of choice 1/2.

According to this embodiment, a UE can appropriately report the RI/CQI for DL CJT CSI.

For problem #4 described above, embodiment #6 below may be applied.

### Embodiment #6

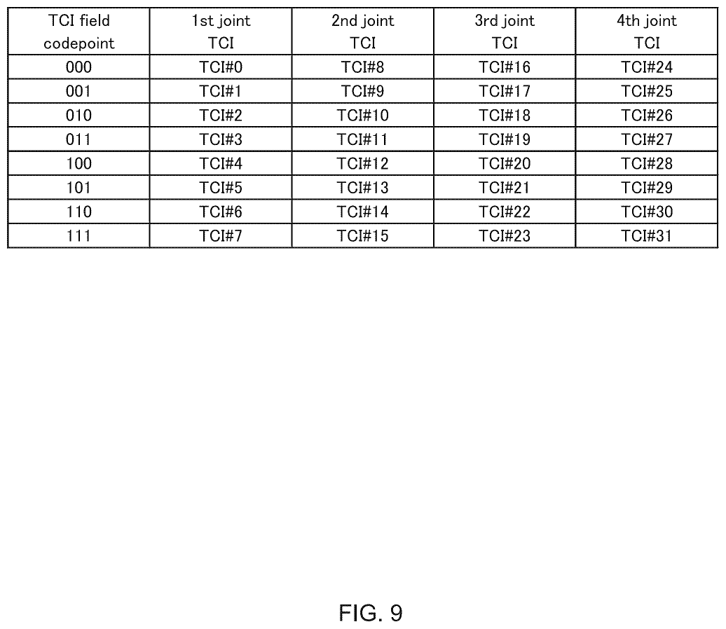

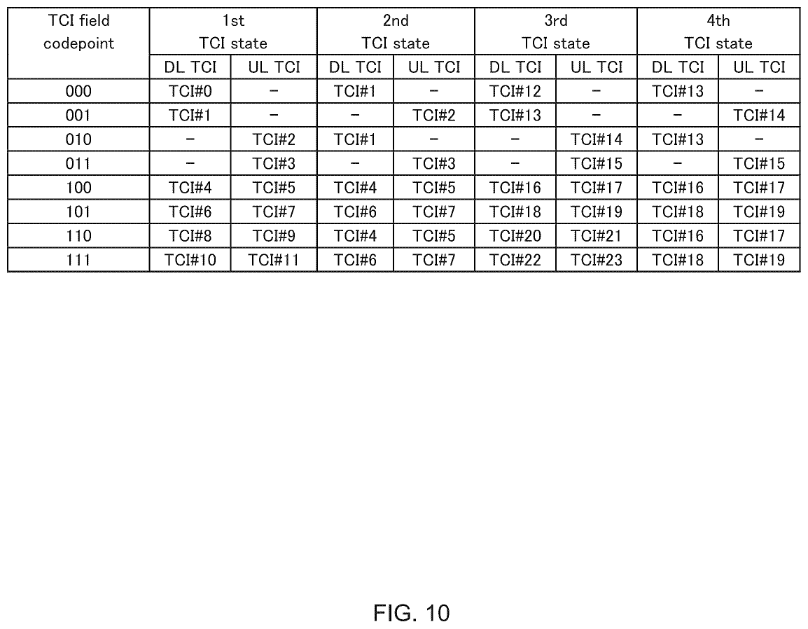

A MAC CE for update of a PDSCH TCI state may update up to four (DL/unified) TCI states (up to X=4) for each TCI codepoint (each codepoint/value of a TCI field) in DCI, in order to support 4-TRP CJT PDSCH transmission. This may mean that each TCI codepoint can correspond to one, two, three, or four indicated TCI states. In the example in FIG. 9, each TCI codepoint is associated with up to four (DL and UL) joint TCI states. In the example in FIG. 10, each TCI codepoint is associated with up to four (DL and UL) separate TCI states.

Explicit or implicit indication of association between each PDSCH DMRS port and each TCI state from X indicated TCI state(s) may be supported. It may be assumed that, when a scenario as high speed train (HST) is supported, each PDSCH DMRS port is QCLed with X TCI state(s).

For indication of up to X TCI state(s), enhancement of a Rel-17/18 unified TCI state for multi-TRP may be further enhanced or may be reused. For example, for a CUT scenario, a MAC CE capable of indicating up to four TCI states may be reused.

According to this embodiment, a TCI state for multi-TRP CJT can be appropriately updated for a UE.

### Embodiment #A

If it is configured for CJT CSI that CSI per TRP is reported in one CSI report, one or more restrictions of restrictions 1 to 3 below may be considered for the CSI per TRP.

### <<Restriction 1>

For the CSI measurement per TRP, the same RI is assumed. Only a common RI report may be needed. For example, an RI report is included in the first CJT CSI, and no RI report may be included in the second/third/fourth CJT CSI. If a different RI report is different for each CSI per TRP, it is difficult for a base station to update the RIs for CJT-CSI.

### <<Restriction 2>>

For each TRP, at least one parameter differentiated from a common parameter(s) is configured. Here, each TRP, each CMR, each CMR group, and each CMR set may be interchangeably interpreted. The parameter may be expressed by at least one of the following parameter fields.
Field (paramCombination) indicating a value/index corresponding to a combination of supported parameters (codebook parameters) (value/index corresponding to a combination of values of at least one of L, pᵥ, β, α)
Field (numberOfPMI-SubbandsPerCQI-Subband) indicating how a PMI subband per CQI subband is defined
The number L of beams (numberOfBeams) used for linear combination
Size of PSK alphabet, QPSK or 8-PSK (phaseAlphasetSize)
Field (subbandAmplitude) being true if subband amplitude reporting is activated
Value of N (valueOfN) (for example, parameter N∈{2, 4} is configured in a case of M=2)

In Rel. 15/16/17, these parameters are configured for each codebook configuration (CodebookConfig) and each CSI report configuration (CSI-ReportConfig). In a CJT CSI configuration, some of these parameters may be configured for each TRP. In the CJT CSI configuration, the CSI of the second/third/fourth TRP may have a coarser feedback granularity and lower overhead than those of the CSI of the first TRP. In paramCombination, different combinations of (L, pᵥ, β) may be configured. For the CJT CSI configuration, part of the parameters common to TRPs (for example, common L) and part of the parameters specific to each TRP (for example, pᵥ, β) may be configured by paramCombination.

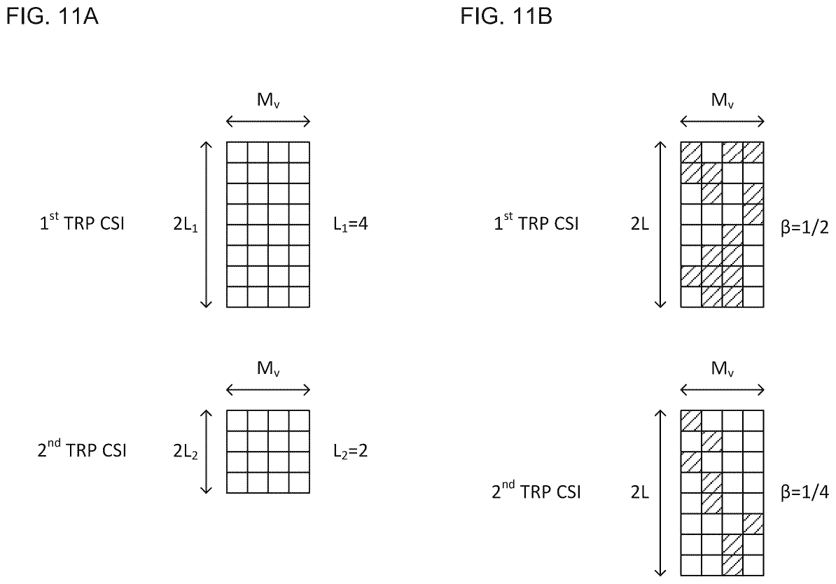

FIG. 11A shows an example of W\tilde{ } for the first TRP and W\tilde{ } for the second TRP. As in this example, for CSI of the first TRP and CSI of the second TRP, different numbers L (L₁, L₂) of SD beams may be configured.

FIG. 11B shows another example of W\tilde{ } for the first TRP and W\tilde{ } for the second TRP. As in this example, the same number L of SD beams and a different maximum number of NZCs (β=1/2, 1/4) for each layer for each TRP may be configured.

### <<Restriction 3>>

In CSI-ReportConfig, for all the X TRPs (all the CMRs/IMRs), at least one of configurations 3a to 3d below is introduced.

{Configuration 3a} the maximum number of non-zero coefficients (NZCs) for each layer of all the X TRPs in CSI-ReportConfig
{Configuration 3b} the maximum number of NZCs for all the layers of all the X TRPs in CSI-ReportConfig
{Configuration 3c} the maximum number of SD beams for all the X TRPs in CSI-ReportConfig
{Configuration 3d} the maximum number of the number Mᵥ of FD bases (FD base vector size) for all the X TRPs in CSI-ReportConfig

UE capability signaling for at least one of restrictions 1 to 3 may be introduced.

According to this embodiment, a UE can appropriately report X pieces of CSI per TRP in one CSI report, based on a restriction/relationship.

### <Supplement>

At least one of the embodiments described above may be applied only to a UE that has reported a specific UE capability or that supports the specific UE capability.

The specific UE capability may indicate at least one of the following:
supporting of specific processing/operation/control/information for at least one of the embodiments above
supporting of a parameter(s) configured by an NW for at least one of the embodiments above
supporting of report contents/report rule for at least one of the embodiments above
supporting of options/choices for at least one of the embodiments above
supporting of reporting of inter-TRP amplitude. supporting of a plurality of codebooks being one or more with different quantization granularity
supporting of reporting of inter-TRP phase. supporting of a plurality of codebooks being one or more with different quantization granularity
supporting of reporting of inter-TRP coefficients (including both amplitude and phase). supporting of a plurality of codebooks being one or more with different quantization granularity
supporting of reporting of a reference CSI indicator
supporting of reporting of an X-TRP CQI (aggregated CJT CQI). supporting of reporting of an X-TRP CQI instead of a single-TRP CQI. supporting of reporting of an X-TRP COI in addition to a single-TRP CQI. supporting of reporting of X-TRP indication such as an X-TRP CQI
whether to support common Mᵥ for a plurality of TRPs or support Mᵥ specific to each TRP, for CJT CSI
supporting of the same Mᵥ size for CJT CSI
supporting of different Mᵥ sizes for CJT CSI
supporting of a start offset for each TRP report, for CJT CSI
whether to support continuous Mᵥ or support discontinuous Mᵥ, for CJT CSI
supporting of Mᵥ specific to each layer for each TRP, for CJT CSI
supporting of Mᵥ common to a plurality of layers for each TRP, for CJT CSI
value of X in X-TRP CJT. a maximum value of X in X-TRP CJT

The specific UE capability above may be capability applied over all the frequencies (in common irrespective of frequency), capability for each frequency (for example, cell, band, or BWP), capability for each frequency range (for example, Frequency Range 1 (FR1), FR2, FR3, FR4, FR5, FR2-1, and FR2-2), or capability for each subcarrier spacing (SCS).

The specific UE capability may be capability applied over all the duplex schemes (in common irrespective of duplex scheme) or capability for each duplex scheme (for example, time division duplex (TDD), or frequency division duplex (FDD)).

At least one of the embodiments above may be applied in a case where a UE is configured with specific information related to the embodiment above by higher layer signaling. For example, the specific information may be information indicating enabling of at least one function of the embodiment above, any RRC parameter for a specific release (for example, Rel. 18), or the like.

When the UE does not support at least one of the specific capabilities or is not configured with any of the specific capabilities above, the UE may apply operation of Rel. 15/16, for example.

### (Supplementary Note A)

Regarding one embodiment of the present disclosure, the following supplementary notes of the invention will be given.

### {Supplementary Note 1}

A terminal including:
a receiving section that receives information of a plurality of transmission/reception points (TRPs) for measurement of channel state information (CSI); and
a control section that determines a group of TRPs of the plurality of TRPs, based on the information.

### {Supplementary Note 2}

The terminal according to supplementary note 1, wherein the group includes two or more co-located TRPs.

### {Supplementary Note 3}

The terminal according to supplementary note 1 or 2, wherein the control section determines whether a parameter of the CSI is the same or different from each other between two TRPs of the plurality of TRPs, based on the group.

### {Supplementary Note 4}

The terminal according to any one of supplementary notes 1 to 3, wherein the control section determines whether a restriction of the CSI is the same or different from each other between two TRPs of the plurality of TRPs, based on the group.

### (Supplementary Note B)

Regarding one embodiment of the present disclosure, the following supplementary notes of the invention will be given.

### {Supplementary Note 1}

A terminal including:
a receiving section that receives information of a plurality of resources corresponding to a plurality of transmission/reception points (TRPs) for measurement of channel state information (CSI); and
a control section that controls reporting of the CSI, based on the information.

### {Supplementary Note 2}

The terminal according to supplementary note 1, wherein the control section selects one or more resources from the plurality of resources, based on the information, and includes the number of the one or more resources in the CSI.

### {Supplementary Note 3}

The terminal according to supplementary note 1 or 2, wherein the control section selects one or more TRPs from the plurality of TRPs, based on the information, and includes the number of the one or more TRPs and one or more indices corresponding to the one or more TRPs in the CSI.

### {Supplementary Note 4}

The terminal according to any one of supplementary notes 1 to 3, wherein one codepoint of a transmission configuration indication (TCI) field in downlink control information is associated with a plurality of TCI states corresponding to the plurality of TRPs.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

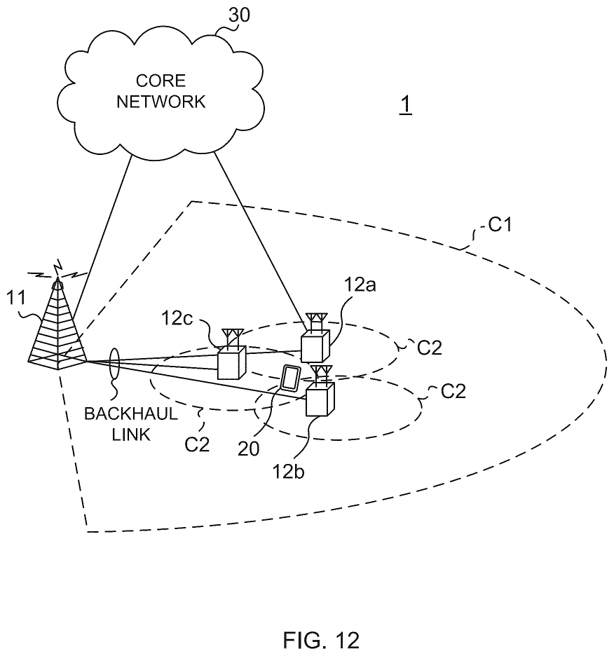

FIG. 12 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and DMRS for PBCH) may be referred to as an SS/PBCH block, an SS Block (SSB), and the like. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal),”

### (Base Station)

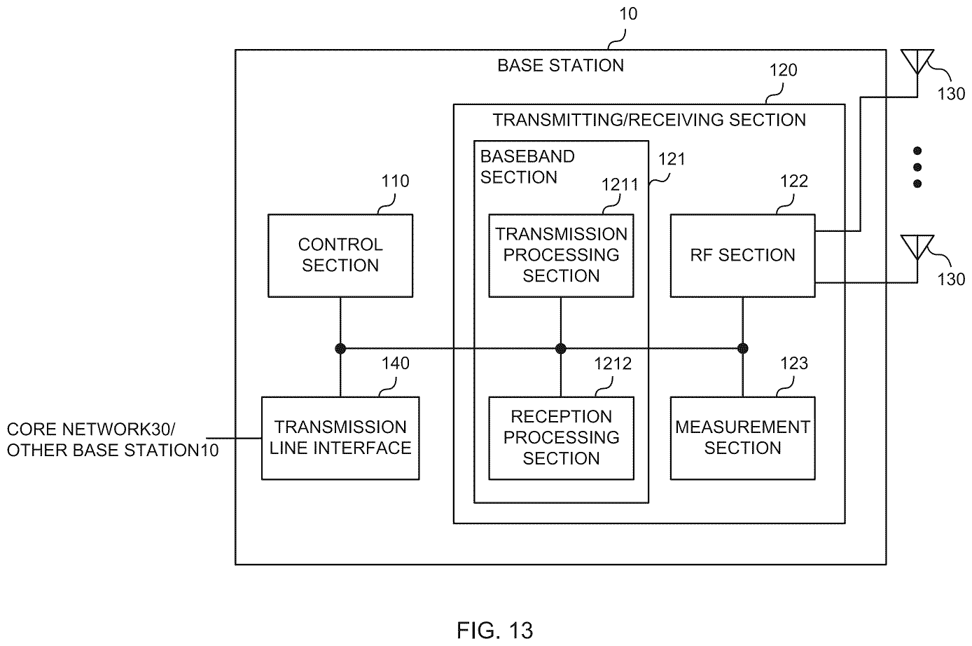

FIG. 13 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211 and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may transmit information of a plurality of transmission/reception points (TRPs) for measurement of channel state information (CSI). The control section 110 may determine a group of TRPs of the plurality of TRPs, based on the information.

The transmitting/receiving section 120 may transmit information of a plurality of resources corresponding to a plurality of respective transmission/reception points (TRPs) for measurement of channel state information (CSI). The control section 110 may control the plurality of resources, based on the information.

### (User Terminal)

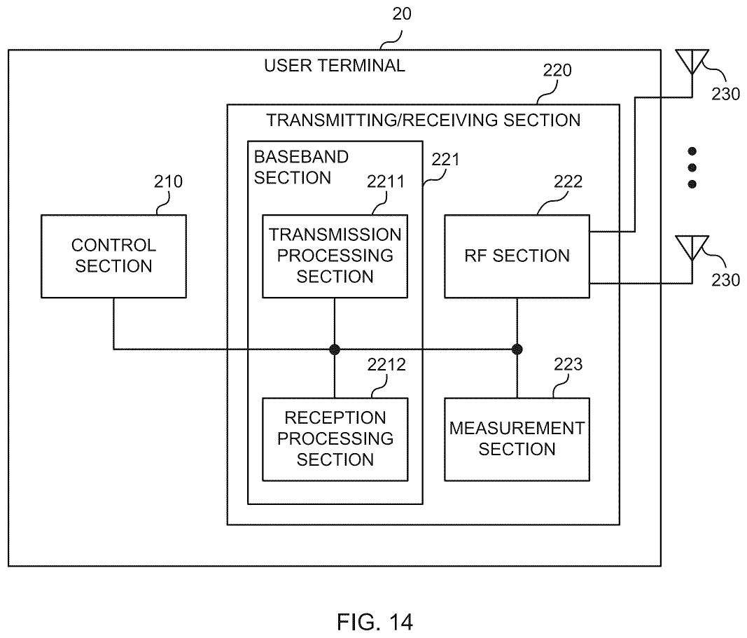

FIG. 14 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RIC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive information (for example, a CSI report configuration, a CMR configuration) of a plurality of transmission/reception points (TRPs) (for example, CMRs/CMR groups/CSI-RS resources/CSI-RS resource sets) for measurement of channel state information (CSI). The control section 210 may determine a group of TRPs of the plurality of TRPs, based on the information.

The group may include two or more co-located TRPs.

The control section may determine whether a parameter (for example, W₁/W_{f}/W₂/Wₖ) of the CSI is the same or different from each other between two TRPs of the plurality of TRPs, based on the group.

The control section may determine whether a restriction of the CSI is the same or different from each other between two TRPs of the plurality of TRPs, based on the group.

The transmitting/receiving section 220 may receive information (for example, a CSI report configuration, a CMR configuration) of a plurality of resources corresponding to a plurality of transmission/reception points (TRPs) (for example, CMRs/CMR groups/CSI-RS resources/CSI-RS resource sets) for measurement of channel state information (CSI). The control section 210 may control reporting of the CSI, based on the information.

The control section may select one or more resources from the plurality of resources, based on the information, and include the number of the one or more resources in the CSI.

The control section may select one or more TRPs from the plurality of TRPs, based on the information, and include the number of the one or more TRPs and one or more indices corresponding to the one or more TRPs in the CSI.

One codepoint of a transmission configuration indication (TCI) field in downlink control information may be associated with a plurality of TCI states corresponding to the plurality of TRPS.

### (Hardware Structure)

Note that the block diagrams that have been used to describe the above embodiments show blocks in functional units. These functional blocks (components) may be implemented in arbitrary combinations of at least one of hardware and software. A Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

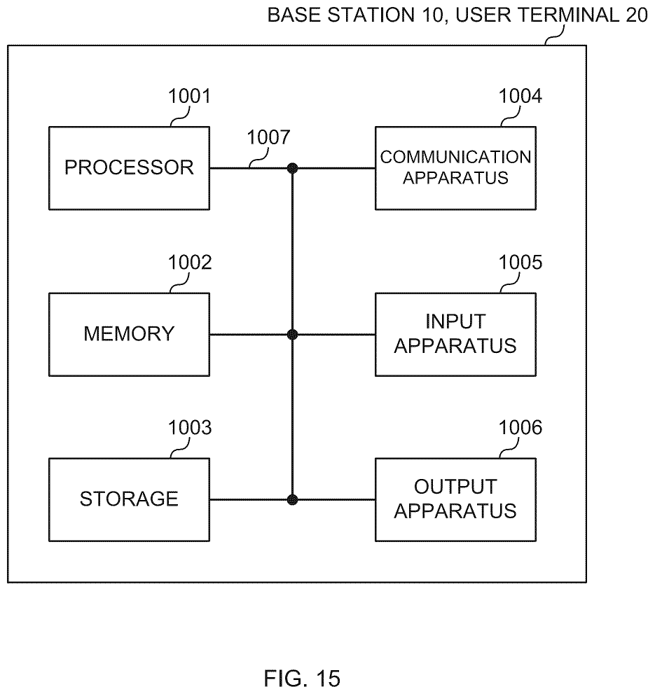

For example, a base station, a user terminal, and so on according to one embodiment of the present disclosure may function as a computer that executes the processes of the radio communication method of the present disclosure. FIG. 15 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) may be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

A BWP may include a UL BWP (BWP for UL) and a DL BWP (BWP for DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP.”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a base station transmitting information to a terminal and the base station indicating control/operation based on the information to the terminal may be interchangeably interpreted.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

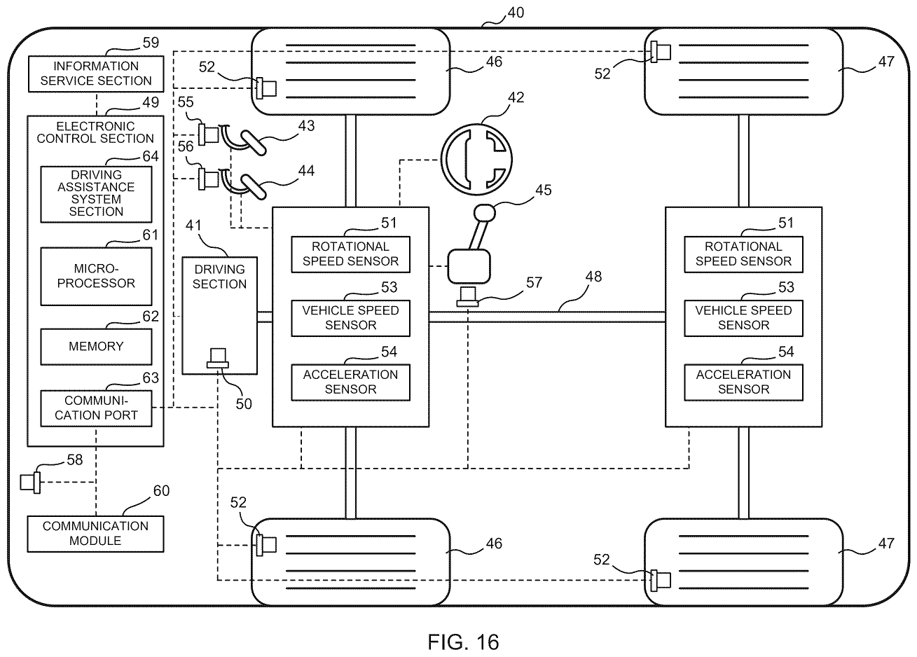

FIG. 16 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like. “The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

The present application is based on Japanese Patent Application No. 2022-081819 filed on May 18, 2022, the entire contents of which are incorporated herein by reference.

1.-6. (canceled)

7. A terminal comprising:
a receiver that receives a higher layer parameter configuring a first mode and a second mode that are associated with a plurality of transmission/reception points (TRPs) for coherent joint transmission; and
a processor that determines whether to include additional information in a report of channel state information (CSI), based on which of the first mode and the second mode is configured.

8. The terminal according to claim 7, wherein the processor includes the additional information as information different for each TRP of the plurality of TRPs, in the CSI.

9. The terminal according to claim 7, wherein the first mode is a mode indicating that the plurality of TRPs are not co-located TRPs, and the second mode is a mode indicating that the plurality of TRPs are co-located TRPs.

10. A radio communication method for a terminal, comprising:
receiving a higher layer parameter configuring a first mode and a second mode that are associated with a plurality of transmission/reception points (TRPs) for coherent joint transmission; and
determining whether to include additional information in a report of channel state information (CSI), based on which of the first mode and the second mode is configured.

11. A base station comprising:
a transmitter that transmits, to a terminal, a higher layer parameter configuring a first mode and a second mode that are associated with a plurality of transmission/reception points (TRPs) for coherent joint transmission; and
a processor that determines, based on which of the first mode and the second mode is configured, whether additional information is included in a report of channel state information (CSI) transmitted from the terminal.

12. A system comprising a terminal and a base station, wherein
the terminal comprises:
a receiver that receives a higher layer parameter configuring a first mode and a second mode that are associated with a plurality of transmission/reception points (TRPs) for coherent joint transmission; and
a processor that determines whether to include additional information in a report of channel state information (CSI), based on which of the first mode and the second mode is configured, and
the base station comprises:
a transmitter that transmits the higher layer parameter; and
a processor that determines, based on which of the first mode and the second mode is configured, whether the additional information is included in the report of the CSI transmitted from the terminal.
